(19) United States
(12) Patent Application Publication
(10) Pub. No.: US 2017/0321600 A1
(43) Pub. Date: Nov. 9, 2017

(54) SYSTEM AND METHOD FOR A GAS TURBINE POWER GENERATION SYSTEM WITH A HIGH PRESSURE COMPRESSOR WITH AN ADDED FORWARD STAGE

(71) Applicant: GENERAL ELECTRIC COMPANY, SCHENECTADY, NY (US)

(72) Inventors: Thomas Ory Moniz, Loveland, OH (US); George Gould Cunningham, III, Lawrenceburg, IN (US); Joseph George Rose, Mason, OH (US)

(21) Appl. No.: 15/148,801

(22) Filed: May 6, 2016

(51) Int. Cl. F02C 3/06; B62D 63/08; F02C 3/107

(52) U.S. Cl. CPC F02C 3/06; F02C 3/107; B62D 63/08; F05D 2230/60; F05D 2240/90; F05D 2220/32

(57) ABSTRACT

The gas turbine power generation system includes a core engine and a low pressure compressor. The core engine includes a high pressure compressor, a combustor, and a high pressure turbine configured in a serial flow arrangement. The high pressure compressor and the high pressure turbine are coupled together by a first shaft. The low pressure compressor is positioned axially forward of the core engine and is coupled to the first shaft.

### BACKGROUND

The field of the disclosure relates generally to gas turbine power generation systems and, more particularly, to a method and a system for a gas turbine power generation system with a high pressure compressor with an added forward stage.

Gas turbine power generation systems typically include a gas turbine driving an electrical generator. Gas turbines typically include gas generator driving a power turbine which, in turn, drives the electrical generator. At least some known gas generators include an intermediate pressure spool to increase the electrical output of the gas turbine power generation system. The intermediate pressure spool includes a booster compressor coupled to an intermediate pressure turbine through an intermediate pressure shaft. While the intermediate pressure spool increases the electrical output of the gas turbine power generation system, it also increases the weight and length of the gas turbine power generation system. The increased weight and length of the gas turbine power generation system reduces the portability of the gas turbine power generation system, increasing the difficulty of transporting the gas turbine power generation system to locations that are without power.

### BRIEF DESCRIPTION

In one aspect, a gas turbine power generation system is provided. The gas turbine power generation system includes a core engine and a low pressure compressor. The core engine includes a high pressure compressor, a combustor, and a high pressure turbine configured in a serial flow arrangement. The high pressure compressor and the high pressure turbine are coupled together by a first shaft. The low pressure compressor is positioned axially forward of the core engine and is coupled to the high pressure compressor.

In another aspect, a method of assembling a gas turbine power generation system assembly is provided. The method includes providing a core gas turbine engine including a high pressure compressor, a combustor, and a high pressure turbine coupled in serial flow communication. The high pressure compressor and the high pressure turbine are coupled together by a first shaft. The method also includes coupling a low pressure compressor to the high pressure compressor axially forward of the high pressure compressor.

In yet another aspect, a mobile gas turbine power generation system is provided. The mobile gas turbine power generation system includes a trailer and a gas turbine power generation system assembly. The trailer includes a flatbed. The gas turbine power generation system assembly is disposed on the flatbed. The gas turbine power generation system assembly includes a core engine and a low pressure compressor. The core engine includes a high pressure compressor, a combustor, and a high pressure turbine configured in a serial flow arrangement. The high pressure compressor and the high pressure turbine are coupled together by a first shaft. The low pressure compressor is coupled to the high pressure compressor and positioned axially forward of the core engine.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1-4 show example embodiments of the method and apparatus described herein.

FIG. 1 is a perspective view of mobile gas turbine power generation system.

FIG. 2 is a schematic cross-sectional view of a gas turbine in accordance with an exemplary embodiment of the present disclosure that may be used with the mobile gas turbine power generation system shown in FIG. 1.

FIG. 3 is a schematic cross-sectional view of a forward portion of a gas generator in accordance with an exemplary embodiment of the present disclosure.

FIG. 4 is a schematic cross-sectional view of a forward portion of a gas generator in accordance with an exemplary embodiment of the present disclosure.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The following detailed description illustrates embodiments of the disclosure by way of example and not by way of limitation. It is contemplated that the disclosure has general application to a system for a power generation system.

Embodiments of the gas turbine power generation system described herein boost the electrical output of a gas turbine power generation system without adding substantial weight and length to the gas turbine power generation system. The gas turbine power generation system includes a gas generator which includes a core engine including a high pressure compressor, a combustor, and a high pressure turbine in a serial flow arrangement. A power turbine is positioned axially aft of the core engine and a low pressure compressor is positioned axially forward of the core engine. The power turbine is rotatably coupled to an electric generator. The low pressure compressor is rotatably coupled to the high pressure compressor directly or through a gearbox, which may be a quill shaft or a bevel gear. The low pressure compressor may be a single stage compressor or a multistage compressor driven by the same shaft or spool as the high pressure compressor. The low pressure compressor may also be bolted directly to the high pressure compressor and boosts the electrical output of the gas turbine power generation system without substantially adding to the weight and length of the gas turbine power generation system.

The gas turbine power generation systems described herein offers advantages over known methods of producing electricity with a gas turbine power generation system. More specifically, some known gas turbines include an intermediate pressure spool to increase the electrical output of the gas turbine power generation system. The intermediate pressure spool includes a low pressure compressor, a shaft, and an intermediate pressure turbine which add to the weight and length of the gas turbine power generation system. In the exemplary embodiment, the electrical output of the gas turbine power generation system is increased by increasing the compression of the input air with an additional low pressure compressor. The low pressure compressor is added to the high pressure compressor without changing the core engine. The electrical output of the gas turbine power generation system is increased without adding an intermediate pressure spool.

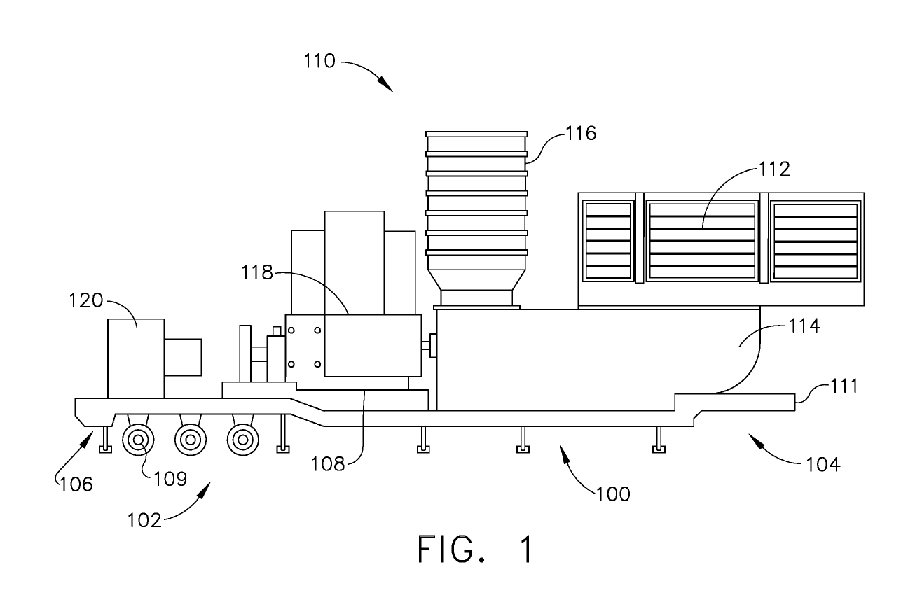

FIG. 1 is a side elevation view of a mobile gas turbine power generation system 100. In the example embodiment, mobile gas turbine power generation system 100 includes a trailer 102 that includes a first end 104, a second end 106, and a flatbed 108 extending therebetween. Mobile gas turbine power generation system 100 also includes a plurality of wheels 109 supporting flatbed 108. In various embodiments, mobile gas turbine power generation system 100 includes skids (not shown) configured to support flatbed 108. Mobile gas turbine power generation system 100 further includes a gas turbine power generation system 110 disposed on flatbed 108. Mobile gas turbine power generation system 100 includes a coupling device 111 configured to receive a complementary coupler (not shown) of a vehicle (not shown) configured to transport gas turbine power generation system 110 using coupling device 111. In various embodiments, gas turbine power generation system 110 includes an inlet and air filter assembly 112, a gas turbine 114, an exhaust stack 116, an electrical generator 118, and a switch gear 120. Inlet and air filter assembly 112 provides combustion air to gas turbine 114 and exhaust stack 116 expels exhaust gases from gas turbine 114. Electrical generator 118 is coupled to gas turbine 114 and generates electric power from gas turbine 114. Switch gear 120 is configured to couple to an electrical grid and protect and isolate the electrical equipment of gas turbine power generation system 110 from the grid.

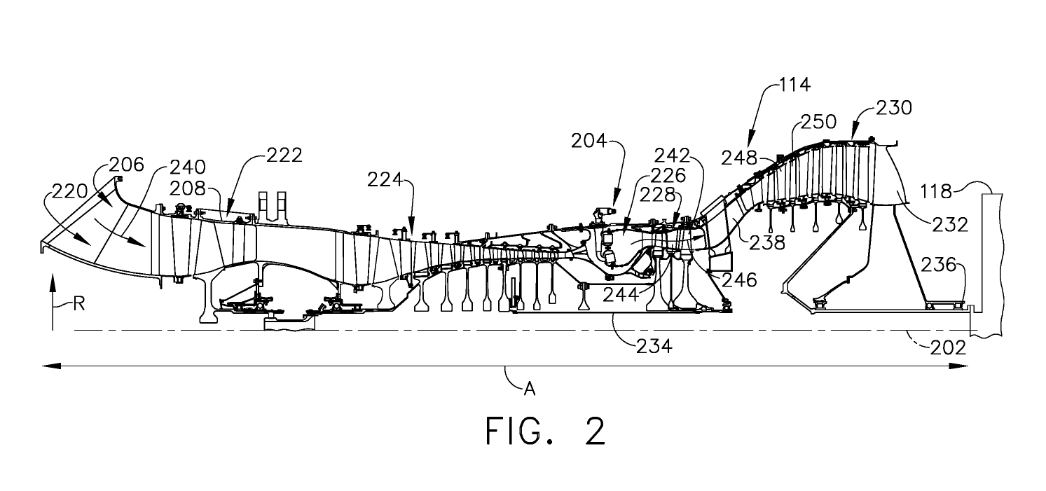

FIG. 2 is a schematic cross-sectional view of gas turbine 114 in accordance with an exemplary embodiment of the present disclosure. As shown in FIG. 2, gas turbine 114 defines an axial direction A (extending parallel to a longitudinal axis 202 provided for reference) and a radial direction R. In general, gas turbine 114 includes a core turbine engine 204 disposed downstream from an air inlet 206.

In the example embodiment, core turbine engine 204 includes an approximately tubular outer casing 208 that defines an annular inlet 220. Outer casing 208 encases, in serial flow relationship, a compressor section including a booster or low pressure (LP) compressor 222 and a high pressure (HP) compressor 224; a combustion section 226; a turbine section including a high pressure (HP) turbine 228 and a power turbine 230; and an exhaust nozzle section 232. A high pressure (HP) shaft or spool 234 drivingly connects HP turbine 228 to HP compressor 224. An output drive 236 drivingly connects power turbine 230 to electrical generator 118 (shown in FIG. 1). The compressor section, combustion section 226, turbine section, and exhaust nozzle section 232 together define a core air flowpath 238.

During operation of gas turbine 114, a volume of air 240 enters gas turbine 114 through inlet and air filter assembly 112 (shown in FIG. 1). Volume of air 240 is directed or routed into core air flowpath 238, or more specifically into LP compressor 222, through annular inlet 220. The pressure of volume of air 240 is then increased as it is routed through LP compressor 222 and HP compressor 224 and into combustion section 226, where it is mixed with fuel and burned to provide combustion gases 242.

Combustion gases 242 are routed through HP turbine 228 where a portion of thermal and/or kinetic energy from combustion gases 242 is extracted via sequential stages of HP turbine stator vanes 244 that are coupled to outer casing 208 and HP turbine rotor blades 246 that are coupled to HP shaft or spool 234, thus causing HP shaft or spool 234 to rotate, which then drives a rotation of HP compressor 224. Combustion gases 242 are then routed through power turbine 230 where a second portion of thermal and kinetic energy is extracted from combustion gases 242 via sequential stages of LP turbine stator vanes 248 that are coupled to outer casing 208 and LP turbine rotor blades 250 that are coupled to output drive 236, which drives a rotation of output drive 236 and electrical generator 118. Electrical generator 118 generates electrical power from rotation of output drive 236. Combustion gases 242 are subsequently routed through exhaust nozzle section 232 of core turbine engine 204 before it is exhausted from exhaust stack 116.

Exemplary gas turbine 114 depicted in FIG. 2 is by way of example only, and that in other embodiments, gas turbine 114 may have any other suitable configuration. It should also be appreciated, that in still other embodiments, aspects of the present disclosure may be incorporated into any other suitable power generation system.

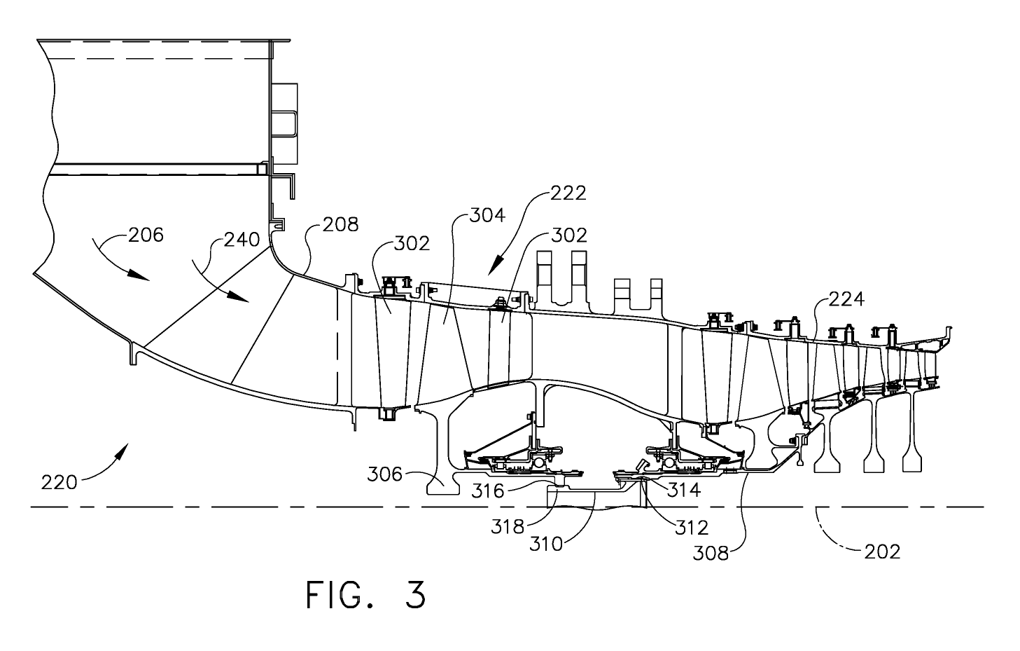

FIG. 3 is a schematic cross-sectional view of a forward portion of gas turbine 114 with a single stage LP compressor 222 in accordance with an exemplary embodiment of the present disclosure. LP compressor 222 includes sequential stages of LP compressor stator vanes 302 that are coupled to outer casing 208 and a single stage LP compressor rotor blade 304 disposed between LP compressor stator vanes 302. Single stage LP compressor rotor blade 304 is coupled to an LP compressor rotor 306. LP compressor rotor 306 is coupled to an HP compressor rotor 308 through a quill shaft 310. Quill shaft 310 is configured to engage HP compressor rotor 308 through a plurality of complementary first end spline teeth 312 and a plurality of complementary HP compressor rotor spline teeth 314 circumferentially spaced about a radially outer periphery of quill shaft 310 and a radially inner periphery of HP compressor rotor 308 respectively. Additionally, quill shaft 310 is configured to engage LP compressor rotor 306 through a plurality of complementary second end spline teeth 316 and a plurality of complementary LP compressor rotor spline teeth 318 circumferentially spaced about a radially outer periphery of quill shaft 310 and a radially inner periphery of LP compressor rotor 306 respectively.

During operation, HP shaft 234 (shown in FIG. 2) drives HP compressor rotor 308 which drives quill shaft 310, LP compressor rotor 306, and single stage LP compressor rotor blade 304. Single stage LP compressor rotor blade 304 increases the pressure volume of air 240 which increases the electrical output of mobile gas turbine power generation system 100. In an alternative embodiment, LP compressor rotor 306 is bolted directly to HP compressor rotor 308, eliminating quill shaft 310. In an alternative embodiment, LP compressor 222 includes multiple stages.

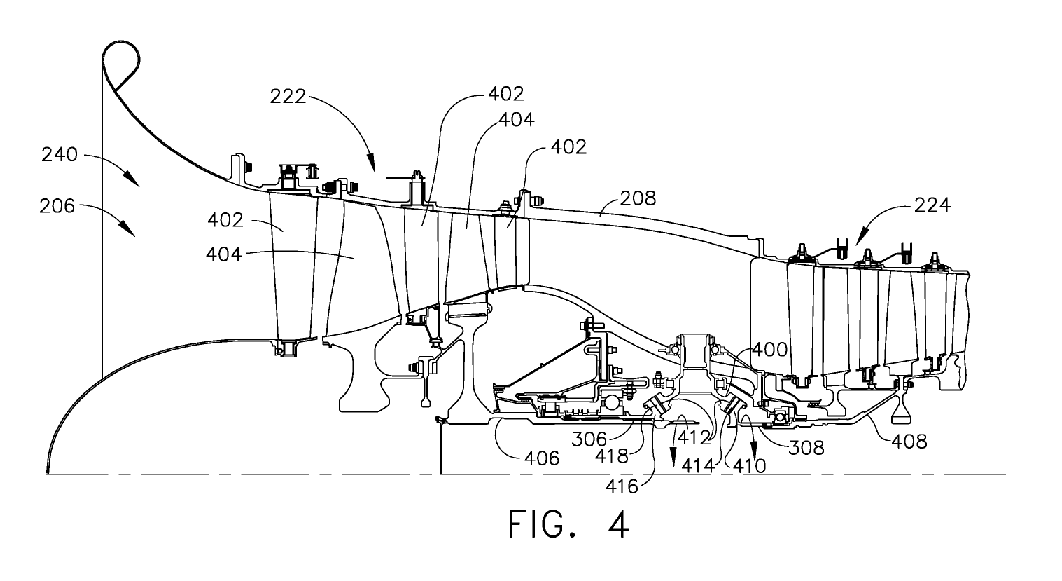

FIG. 4 is a schematic cross-sectional view of a forward portion of a gas turbine 114 with a multi-stage LP compressor 222 and a beveled gear 400 in accordance with an exemplary embodiment of the present disclosure. LP compressor 222 includes sequential stages of LP compressor stator vanes 402 that are coupled to outer casing 208 and LP compressor rotor blades 404 disposed between LP compressor stator vanes 402. LP compressor rotor blade 404 is coupled to an LP compressor rotor 406. LP compressor rotor 406 is coupled to an HP compressor rotor 408 through beveled gear 400. HP compressor rotor 408 includes an HP compressor bevel gear 410. Bevel gear 400 is configured to engage HP compressor rotor 408 through a plurality of complementary bevel gear teeth 412 and a plurality of complementary HP compressor bevel gear teeth 414 circumferentially spaced about a radially outer periphery of bevel gear 400 and a radially outer periphery of HP compressor bevel gear 410 respectively. LP compressor rotor 406 includes a LP compressor bevel gear 416. Bevel gear 400 is configured to engage LP compressor rotor 406 through bevel gear teeth 412 and a plurality of complementary LP compressor bevel gear teeth 418 circumferentially spaced about a radially outer periphery of bevel gear 400 and a radially outer periphery of LP compressor bevel gear 416 respectively.

During operation, HP shaft 234 (shown in FIG. 2) drives HP compressor rotor 408 which drives bevel gear 400, LP compressor rotor 406, and LP compressor rotor blades 404. LP compressor rotor blades 404 increase the pressure volume of air 240 which increases the electrical output of mobile power generation system 100. In an alternative embodiment, LP compressor rotor 406 is bolted directly to HP compressor rotor 408, eliminating bevel gear 400.

In another embodiment, LP compressor 222 is bolted directly on HP compressor 224 of an already existing gas turbine 114. The additional LP compressor 222 adds additional power to existing gas turbine 114 without adding substantial weight and length to existing gas turbine 114.

The above-described gas turbine power generation systems provide an efficient method for providing power with a gas turbine power generation system. Specifically, the above-described gas turbine power generation systems include an additional low pressure compressor coupled to the high pressure compressor to increase the compression of incoming air. Increasing the compression of incoming air increases the electrical output of the gas turbine power generation system without adding an intermediate pressure spool. As such, adding an additional low pressure compressor increases the electrical output of the gas turbine power generation system without adding substantial weight and length to the generator.

Exemplary embodiments of the gas turbine power generation system are described above in detail. The gas turbine power generation system, and methods of operating such systems and devices are not limited to the specific embodiments described herein, but rather, components of systems and/or steps of the methods may be utilized independently and separately from other components and/or steps described herein. For example, the methods may also be used in combination with other systems requiring power generation, and are not limited to practice with only the systems and methods as described herein. Rather, the exemplary embodiment can be implemented and utilized in connection with many other machinery applications that are currently configured to receive and accept gas turbine power generation systems.

Example methods and apparatus for producing electricity with a gas turbine power generation system are described above in detail. The apparatus illustrated is not limited to the specific embodiments described herein, but rather, components of each may be utilized independently and separately from other components described herein. Each system component can also be used in combination with other system components.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gas turbine power generation system assembly comprising:
a core engine comprising a high pressure compressor, a combustor, and a high pressure turbine in a serial flow arrangement, said high pressure compressor and said high pressure turbine coupled together using a first shaft; and
a low pressure compressor coupled to said high pressure compressor and positioned axially forward of said core engine.

2. The gas turbine power generation system assembly of claim 1 further comprising a power turbine coupled in flow communication with said core engine and positioned axially aft of said core engine.

3. The gas turbine power generation system assembly of claim 2, wherein said power turbine is operatively coupled to an electrical generator.

4. The gas turbine power generation system assembly of claim 1, wherein said low pressure compressor comprises a single stage.

5. The gas turbine power generation system assembly of claim 1, wherein said low pressure compressor comprises multiple stages.

6. The gas turbine power generation system assembly of claim 1 further comprising a second shaft including a first end and a second end, said first end includes a first spline assembly and said second end includes a second spline assembly, said first spline assembly coupled to said first shaft and said second spline assembly coupled to said low pressure compressor, said first shaft configured to rotate said first spline assembly, said second shaft, and said second spline assembly, said second spline assembly configured to rotate said low pressure compressor.

7. The gas turbine power generation system assembly of claim 1 further comprising a bevel gear coupled to said first shaft and said low pressure compressor, said first shaft configured to rotate said bevel gear, said bevel gear configured to rotate said low pressure compressor.

8. A method of assembling a gas turbine power generation system assembly, the method comprising:
providing a core gas turbine engine including a high pressure compressor, a combustor, and a high pressure turbine coupled in serial flow communication, the high pressure compressor and the high pressure turbine coupled together using a first shaft; and
coupling a low pressure compressor to the high pressure compressor axially forward of the high pressure compressor.

9. The method of claim 8, wherein coupling a low pressure compressor to the shaft axially forward of the high pressure compressor comprises coupling a single stage low pressure compressor to the first shaft axially forward of the high pressure compressor.

10. The method of claim 8, wherein coupling a low pressure compressor to the shaft axially forward of the high pressure compressor comprises coupling a multiple stage low pressure compressor to the shaft axially forward of the high pressure compressor.

11. The method of claim 8 further comprising coupling a power turbine axially aft of the core engine.

12. The method of claim 11 further comprising coupling the power turbine to an output drive.

13. The method of claim 11 further comprising coupling the power turbine to an electrical generator.

14. A mobile gas turbine power generation system assembly comprising:
a trailer comprising a flatbed;
a gas turbine power generation system assembly disposed on said flatbed, said gas turbine power generation system assembly comprising:
a core engine comprising a high pressure compressor, a combustor, and a high pressure turbine in a serial flow arrangement, said high pressure compressor and said high pressure turbine coupled together using a first shaft; and
a low pressure compressor coupled to said high pressure compressor and positioned axially forward of said core engine.

15. The mobile gas turbine power generation system assembly of claim 14 further comprising a power turbine coupled in flow communication with said core engine and positioned axially aft of said core engine.

16. The mobile gas turbine power generation system assembly of claim 15, wherein said power turbine is operatively coupled to an electrical generator.

17. The mobile gas turbine power generation system assembly of claim 14, wherein said low pressure compressor comprises a single stage.

18. The mobile gas turbine power generation system assembly of claim 14, wherein said low pressure compressor comprises multiple stages.

19. The mobile gas turbine power generation system assembly of claim 14 further comprising a second shaft including a first end and a second end, said first end includes a first spline assembly and said second end includes a second spline assembly, said first spline assembly coupled to said first shaft and said second spline assembly coupled to said low pressure compressor, said first shaft configured to rotate said first spline assembly, said second shaft, and said second spline assembly, said second spline assembly configured to rotate said low pressure compressor.

20. The mobile gas turbine power generation system assembly of claim 14 further comprising a bevel gear coupled to said first shaft and said low pressure compressor, said first shaft configured to rotate said bevel gear, said bevel gear configured to rotate said low pressure compressor.
